(19) United States
(12) Patent Application Publication
(10) Pub. No.: US 2002/0144259 A1
(43) Pub. Date: Oct. 3, 2002

(54) Method and apparatus for controlling a media player based on user activity

(75) Inventors: Srinivas Gutta, Buchanan, NY (US); Antonio J. Colmenarez, Peekskill, NY (US); Miroslav Trajkovic, Ossining, NY (US)

Correspondence Address: Michael E. Marion, Corporate Patent Counsel, U.S. Philips Corporation, 580 White Plains Road, Tarrytown, NY, 10591, US

(73) Assignee: Philips Electronics North America Corp.

(21) Appl. No.: 09/821,183

(22) Filed: Mar. 29, 2001

(51) Int. Cl. H04H 9/00; H04N 7/16

(52) U.S. Cl. 725/10; 725/12

(57) ABSTRACT

A media player controller is disclosed that monitors user activity and automatically controls a media player in response to predefined events. The disclosed media player controller includes one or more audio/visual mage capture devices focused on one or more users. The captured audio and video information is processed by the media player controller to identify one or more predefined events. A number of rules can be utilized to define various user events, such as when the user has left the room, is on the telephone or is otherwise paying attention to the media player. Each rule contains one or more conditions, and, optionally, a corresponding action-item that should be performed when the rule is satisfied. Upon detection of a predefined event, the corresponding action, if any, is performed by the media player controller.

### FIELD OF THE INVENTION

The present invention relates to methods and apparatus for controlling media players, and more particularly, to a method and apparatus for automatically controlling a media player based on user activity.

### BACKGROUND OF THE INVENTION

The consumer marketplace offers a wide variety of electronic devices, such as televisions, stereo systems and personal computers, that provide an ever-growing number of features intended to increase the convenience and capabilities of these devices. Most entertainment devices, for example, have an associated remote control device that allows the user to adjust a number of the device settings remotely. For example, a user can adjust the program channel, volume and other settings of a television using a remote control, in a well-known manner.

While remote controls and other additional features have greatly improved the convenience of such entertainment devices, they still require the affirmative action of the user to manipulate the remote control (or another input mechanism associated with the device) to indicate the manner in which the particular device settings should be adjusted. Thus, if the remote control is not readily available, or the user does not wish to move closer to the device itself, the user may still be unable to conveniently adjust one or more settings in a desired manner.

It has been observed that there is often a predictable relationship between certain user activity and a corresponding manner in which the settings of an electronic device should be adjusted. For example, when the telephone rings while a user is watching television, the user often responds by manually adjusting the volume or activating the mute feature of the television. There is currently no mechanism, however, that provides an indication to an electronic device of such user activity. A need therefore exists for a media player controller that monitors user activity and automatically adjusts a media player in response to predefined events. A further need exists for a media player controller that employs a rule-base to define user activities or events, as well as the corresponding response that should be implemented to adjust device settings.

### SUMMARY OF THE INVENTION

Generally, a method and apparatus are disclosed for monitoring user activity and automatically controlling a media player in response to predefined events. The disclosed media player controller includes one or more audio/visual capture devices focused on one or more users. The obtained audio and video information is processed by the media player controller to identify one or more predefined events.

According to one aspect of the invention, a number of rules define various user activities or events, such as when the user has left the room, is on the telephone or is otherwise not paying attention to the media player. Each rule contains one or more conditions, and, optionally, a corresponding action-item that should be performed when the rule is satisfied to adjust one or more settings of the media player. Upon detection of a predefined event, the corresponding action, if any, is performed by the media player controller.

A more complete understanding of the present invention, as well as further features and advantages of the present invention, will be obtained by reference to the following detailed description and drawings.

### BRIEF DESCRIPTION OF THE DRAWINGS

FIG. 1 illustrates a media player controller in accordance with the present invention;

FIG. 2 illustrates a sample table from the user profile of FIG. 1 in accordance with the present invention;

FIG. 3 illustrates a sample table from the user event database of FIG. 1; and

FIG. 4 is a flow chart describing an exemplary user event monitoring process embodying principles of the present invention.

### DETAILED DESCRIPTION

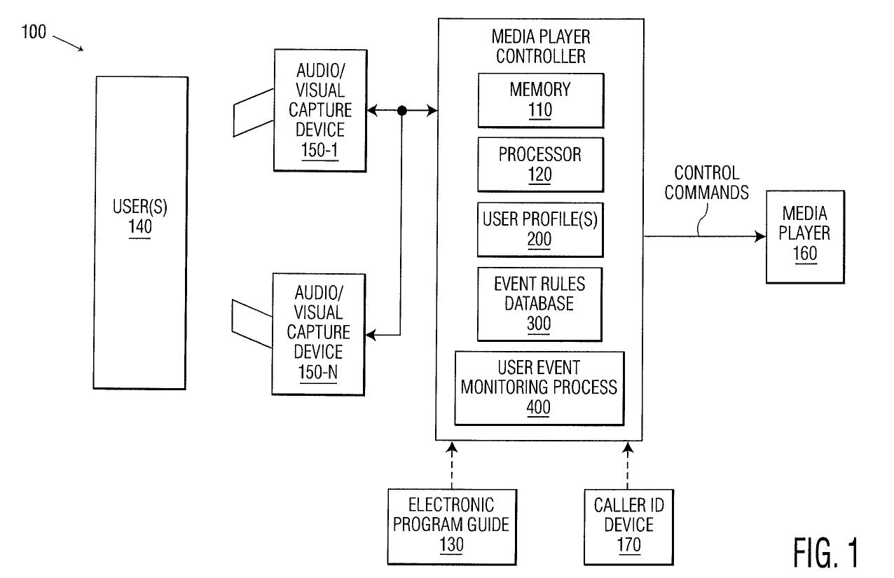

FIG. 1 illustrates a media player controller 100 in accordance with the present invention. As shown in FIG. 1, the media player controller 100 includes one or more audio/visual capture devices 150-1 through 150-N (hereinafter, collectively referred to as audio/visual capture devices 150) that are focused on one or more user(s) 140 of a media player 160.

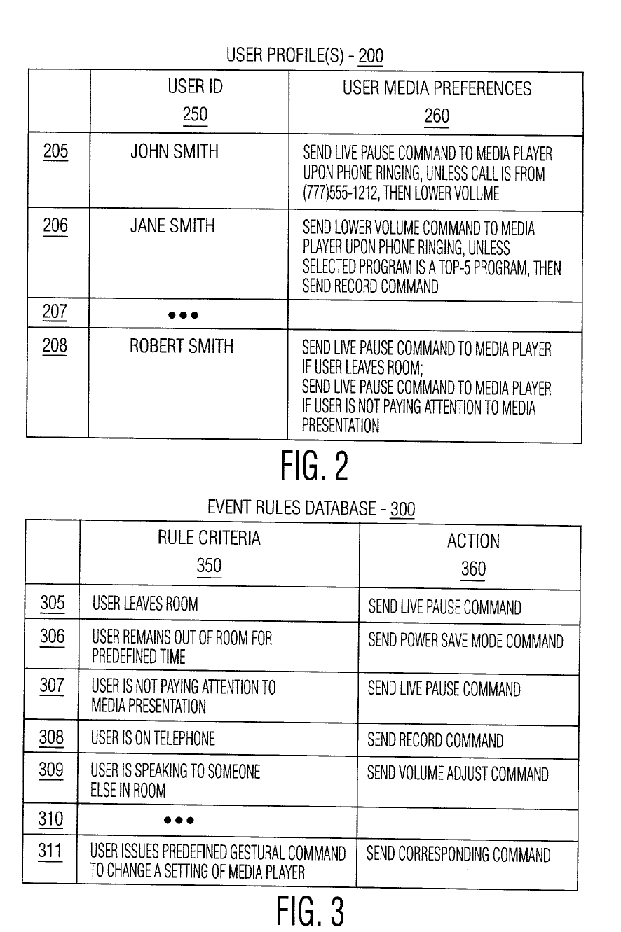

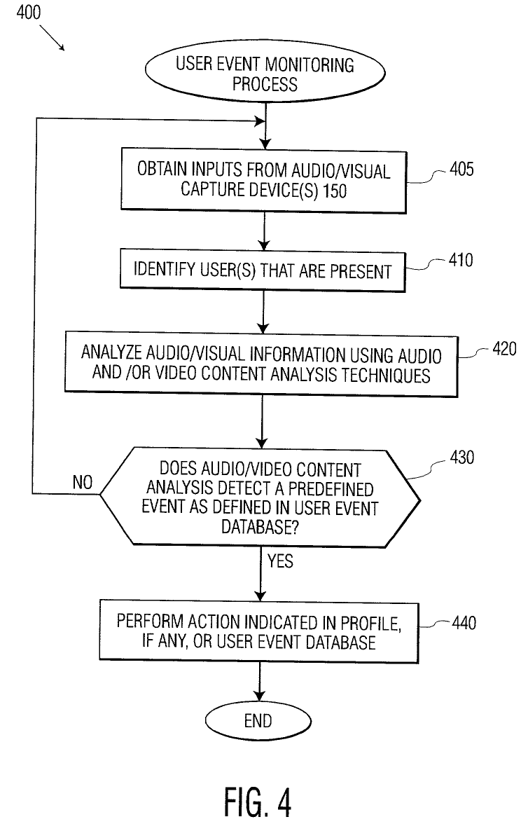

Each audio/visual capture device 150 may be embodied, for example, as a fixed or pan-tilt-zoom (PTZ) camera for capturing image or video information, or one or more microphones for capturing audio information (or both). The audio and video information generated by the audio/visual capture devices 150 are processed by the media player controller 100, in a manner discussed below in conjunction with FIG. 4, to identify one or more predefined user activities or events. In one implementation, the present invention employs a user profile 200 and event rules database 300, discussed further below in conjunction with FIGS. 2 and 3, that record a number of user preferences and rules, respectively. The rules define various events that should initiate an adjustment of one or more settings of the media player 160.

The user activities defined by each rule may be detected by the media player controller 100 in accordance with the present invention. As discussed further below, each rule contains one or more criteria that must be satisfied in order for the rule to be triggered, and, optionally, a corresponding action-item that should be performed by the media player controller 100 to adjust one or more settings of the media player 160 when the predefined criteria for initiating the rule is satisfied. At least one of the criteria for each rule is a condition detected in the audio or video information generated by the audio/visual capture devices 150 using audio or vision-based techniques, in accordance with the present invention.

Upon detection of such a predefined user activity or event, the corresponding action, if any, is performed by the media player controller 100. Typically, the corresponding action is the issuance of a command to the media player 160 to adjust one or more settings. The commands include, for example, mute, record, volume adjust, change program channel, power save mode and live pause.

As discussed further below in conjunction with FIGS. 2 and 3, the user preferences and rules recorded in the user profile 200 and event rules database 300 may include one or more criteria that is dependent on external information, such as information from an optional electronic program guide 130 or caller id (identification) device 170. For example, the corresponding action-item that is performed by the media player controller 100 in response to a given user activity may be dependent on features of a program, as indicated in the electronic program guide 130. Similarly, the corresponding action-item that is performed by the media player controller 100 in response to the media player controller 100 detecting that the telephone is ringing may be dependent on the identity of the caller, as indicated by the caller id device 170.

As shown in FIG. 1, and discussed further below in conjunction with FIG. 4, the media player controller 100 also contains a user event monitoring process 400. Generally, the user event monitoring process 400 processes the audio information or images obtained by the audio/visual capture devices 150 and detects one or more events defined in the event rules database 300.

The media player controller 100 may be embodied as any computing device, such as a personal computer or workstation, that contains a processor 120, such as a central processing unit (CPU), and memory 110, such as RAM and/or ROM. Alternatively, the media player controller 100 may be embodied as an application specific integrated circuit (ASIC) (not shown) that is included, for example, in a television, set-top terminal or another electronic device.

FIG. 2 illustrates an exemplary table of the user profile(s) 200 that records various preferences of each user. As shown in FIG. 2, the user profile 200 is comprised of a plurality of records, such as records 205-208, each associated with a different user. For each user, the user profile 200 identifies the user in field 250 and the corresponding media preferences of the user, if any, in field 260.

For example, the user preferences recorded in record 205 for the user, John Smith, indicates that the user likes to pause the media player 160 when the telephone rings, unless the call is from a particular telephone number, upon which the volume of the media player 160 is lowered. Likewise, the user preferences recorded in record 206 for the user, Jane Smith, indicates that the user likes to lower the volume of the media player 160 when the telephone rings, unless the current selected program is a top-5 program, upon which a record command is sent to the media player 160. Thus, the preferences in record 205 are dependent upon information from the caller id device 170, and the preferences in record 206 are dependent upon information from the electronic program guide 130.

Generally, the user preferences recorded in the user profile(s) 200 can be obtained explicitly, i.e., from survey responses, or implicitly, by monitoring how a given user responds to a given set of circumstances. Thereafter, a rule can be established that defines the given set of circumstances and the correspond action item that should be performed.

FIG. 3 illustrates an exemplary table of the event rules database 300 that records each of the rules that define various user activities or events. Each rule in the event rules database 300 includes predefined criteria specifying the conditions under which the rule should be initiated, and, optionally, a corresponding action item that should be triggered when the criteria associated with the rule is satisfied. Typically, the action item defines one or more adjustments to the settings of the media player 160 that should be performed when the rule is triggered.

As shown in FIG. 3, the exemplary event rules database 300 maintains a plurality of records, such as records 305-311, each associated with a different rule. For each rule, the event rules database 300 identifies the rule criteria in field 350 and the corresponding action item, if any, in field 360. For example, the rule recorded in record 306 is an event corresponding to the user remaining out of the room (or away from the vicinity of the media player 160). As indicated in field 350, the rule in record 306 is triggered when the user remains out of the room for a predefined minimum time interval. As indicated in field 360, the corresponding action consists of sending a command to place the media player 160 in a power save mode.

FIG. 4 is a flow chart describing an exemplary user event monitoring process 400. The user event monitoring process 400 processes audio or video information (or both) obtained from the audio/visual capture devices 150 and detects one or more events defined in the event rules database 300. The exemplary user event monitoring process 400 is a general process illustrating the broad concepts of the present invention. As shown in FIG. 4, the user event monitoring process 400 initially obtains one or more inputs from the audio/visual capture devices 150 during step 405. Thereafter, the user event monitoring process 400 optionally identifies the user(s) that are present during step 410, for example, using a biometric evaluation of the audio or visual information obtained from the audio/visual capture device 150. A user identification is particularly useful when the media player controller 100 permits user-specific media preferences set forth in the user profile(s) 200 to control over the general rules set forth in the event rules database 300.

Thereafter, the audio/visual information is analyzed during step 420 using audio and/or video content analysis (VCA) techniques. For a detailed discussion of suitable audio content analysis techniques, see, for example, Silvia Pfeiffer et al., “Automatic Audio Content Analysis,” Proc. ACM Multimedia 96, 21-30, Boston, Mass. (November 1996), incorporated by reference herein. For a detailed discussion of suitable VCA techniques, see, for example, Nathanael Rota and Monique Thonnat, “Video Sequence Interpretation for Visual Surveillance,” in Proc. of the 3d IEEE Int'l Workshop on Visual Surveillance, 59- 67, Dublin, Ireland (Jul. 1, 2000), and Jonathan Owens and Andrew Hunter, “Application of the Self-Organizing Map to Trajectory Classification,’ in Proc. of the 3d IEEE Int'l Workshop on Visual Surveillance, 77-83, Dublin, Ireland (Jul. 1, 2000), incorporated by reference herein. Generally, the audio content analysis and VCA techniques are employed to recognize various features in the signals obtained by the audio/visual capture devices 150.

A test is performed during step 430 to determine if the audio/video content analysis detects a predefined event, as defined in the event rules database 300. It is noted that the general rules set forth in the event rules database 300, as analyzed during step 430, may be modified in accordance with the specific user preferences set forth in the user profile 200. If it is determined during step 430 that the audio/video content analysis does not detect a predefined event, then program control returns to step 410 to continue monitoring user activities in the manner discussed above.

If, however, it is determined during step 430 that the audio/video content analysis detects a predefined event, then the event is processed during step 440 as indicated in field 260 of the user profile 200, if any, for the identified user or field 360 of the event rules database 300. Program control then terminates (or returns to step 410 and continues monitoring user activities in the manner discussed above).

In a further variation, the retention schedule for a given program that is recorded in accordance with the present invention can be determined, for example, by a weight assigned to the program by a user or by a recommendation score assigned by a program recommender.

It is to be understood that the embodiments and variations shown and described herein are merely illustrative of the principles of this invention and that various modifications may be implemented by those skilled in the art without departing from the scope and spirit of the invention.

What is claimed is:

1. A method for controlling a media player, comprising:
establishing at least one rule defining a predefined user activity, said rule including at least one condition and an action item to be performed to automatically adjust said media player when said rule is satisfied;
analyzing at least one of audio and video information focused on a user to identify said condition; and
performing said action item if said rule is satisfied.

2. The method of claim 1, wherein said user activity suggests that said user is not paying attention to said media player and said action item is the issuance of a command to pause said media player.

3. The method of claim 1, wherein said user activity suggests that said user is not paying attention to said media player and said action item is the issuance of a command to said media player to begin recording.

4. The method of claim 1, wherein said user activity suggests that said user is not paying attention to said media player and said action item is the issuance of a command to said media player to enter a power save mode.

5. The method of claim 1, wherein said user activity is a predefined gestural command and said action item is the issuance of a corresponding command to said media player.

6. A method for controlling a media player, comprising:
analyzing at least one of audio and video information focused on a user to identify at least one predefined user activity; and
performing a predefined action item to automatically adjust said media player when said user activity is identified.

7. The method of claim 6, wherein said user activity suggests that said user is not paying attention to said media player and said action item is the issuance of a command to pause said media player.

8. The method of claim 6, wherein said user activity suggests that said user is not paying attention to said media player and said action item is the issuance of a command to said media player to begin recording.

9. The method of claim 6, wherein said user activity suggests that said user is not paying attention to said media player and said action item is the issuance of a command to said media player to enter a power save mode.

10. The method of claim 6, wherein said user activity is a predefined gestural command and said action item is the issuance of a corresponding command to said media player.

11. A system for controlling a media player, comprising:
a memory for storing computer readable code; and
a processor operatively coupled to said memory, said processor configured to:
establish at least one rule defining a predefined user activity, said rule including at least one condition and an action item to be performed to automatically adjust said media player when said rule is satisfied;
analyze at least one of audio and video information focused on a user to identify said condition; and
perform said action item if said rule is satisfied.

12. The system of claim 11, wherein said user activity suggests that said user is not paying attention to said media player and said action item is the issuance of a command to pause said media player.

13. The system of claim 11, wherein said user activity suggests that said user is not paying attention to said media player and said action item is the issuance of a command to said media player to begin recording.

14. The system of claim 11, wherein said user activity suggests that said user is not paying attention to said media player and said action item is the issuance of a command to said media player to enter a power save mode.

15. The system of claim 11, wherein said user activity is a predefined gestural command and said action item is the issuance of a corresponding command to said media player.

16. A system for controlling a media player, comprising:
a memory for storing computer readable code; and
a processor operatively coupled to said memory, said processor configured to:
analyze at least one of audio and video information focused on a user to identify at least one predefined user activity; and
perform a predefined action item to automatically adjust said media player when said user activity is identified.

17. The system of claim 16, wherein said user activity suggests that said user is not paying attention to said media player and said action item is the issuance of a command to pause said media player.

18. The system of claim 16, wherein said user activity suggests that said user is not paying attention to said media player and said action item is the issuance of a command to said media player to begin recording.

19. The system of claim 16, wherein said user activity suggests that said user is not paying attention to said media player and said action item is the issuance of a command to said media player to enter a power save mode.

20. The system of claim 16, wherein said user activity is a predefined gestural command and said action item is the issuance of a corresponding command to said media player.

21. An article of manufacture for controlling a media player, comprising:
a computer readable medium having computer readable code means embodied thereon, said computer readable program code means comprising:
a step to establish at least one rule defining a predefined user activity, said rule including at least one condition and an action item to be performed to automatically adjust said media player when said rule is satisfied;
a step to analyze at least one of audio and video information focused on a user to identify said condition; and
a step to perform said action item if said rule is satisfied.

22. An article of manufacture for controlling a media player, comprising:
a computer readable medium having computer readable code means embodied thereon, said computer readable program code means comprising:
a step to analyze at least one of audio and video information focused on a user to identify at least one predefined user activity; and
a step to perform a predefined action item to automatically adjust said media player when said user activity is identified.
